(19) United States
(12) Patent Application Publication
(10) Pub. No.: US 2007/0162691 A1
(43) Pub. Date: Jul. 12, 2007

(54) Apparatus and method to store information

(76) Inventor: Snehal Sanmukhbhai Bhakta, Tucson, AZ (US)

Correspondence Address: DALE F. REGELMAN, 4231 S. FREMONT AVENUE, TUCSON, AZ, 85714, US

(21) Appl. No.: 11/326,649

(22) Filed: Jan. 6, 2006

(51) Int. Cl. G06F 12/00; G06F 13/00

(52) U.S. Cl. 711/112; 711/165

(57) ABSTRACT

A method to store data is disclosed. The method supplies a computing system comprising a computing device, a first DASD in communication with the computing device, a second DASD in communication with the computing device, and a plurality of non-DASD data storage devices in communication with the computing device. The method migrates a dataset from the first DASD to the second DASD, and subsequently copies the dataset from the second DASD to one or more of the plurality on non-DASD data storage devices.

### FIELD OF THE INVENTION

The invention relates to an apparatus and method to store data in a computing system. In certain embodiments, the invention is directed to a method to store data in a computing system comprising a computing device, a first DASD in communication with the computing device, a second DASD in communication with the computing device, and a plurality of non-DASD data storage devices in communication with the computing device.

### BACKGROUND OF THE INVENTION

Prior art hierarchical storage management (“HSM”) systems migrate data from one storage technology to another storage technology, such as for example magnetic disk. From magnetic disk the data might be migrated to magnetic tape for example. Prior art methods often migrated data from a more expensive, faster-access storage medium to less expensive, slower-access storage medium based upon anticipated future storage capacity needs for the faster-access medium. Applicants have found that such anticipation-based data migration is often premature, resulting in increased costs and decreased data access times.

What is needed is an apparatus and method that keeps data available in a faster-access storage medium until that data actually needs to be removed therefrom.

### SUMMARY OF THE INVENTION

Applicants' invention comprises a method to store data. The method supplies a computing system comprising a computing device, a first DASD in communication with the computing device, a second DASD in communication with the computing device, and a plurality of non-DASD data storage devices in communication with the computing device. The method migrates a dataset from the first DASD to the second DASD, and subsequently copies the dataset from the second DASD to one or more of the plurality on non-DASD data storage devices, such that a first copy of the dataset remains written to the second DASD and a second copy is written to the plurality of non-DASD data storage devices.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing Applicants' computing system;

FIG. 2 is a block diagram illustrating a step of Applicants' method wherein a dataset is written to a first DASD;

FIG. 3 is a block diagram illustrating a step of Applicants' wherein the dataset of FIG. 2 is migrated from the first DASD to a second DASD;

FIG. 4 is a block diagram illustrating a prior art data storage method wherein the dataset of FIG. 2 is migrated from the second DASD to a magnetic tape data storage medium;

FIG. 5 is a block diagram illustrating a step of Applicants' wherein the dataset of FIG. 2 is copied from the second DASD to a magnetic tape data storage medium;

FIG. 6 is a flow chart summarizing the steps of Applicants' method.

### DETAILED DESCRIPTION OF THE PREFERRED EMBODIMENTS

Referring to figures, wherein like parts are designated with the same reference numerals and symbols. The invention will be described as embodied in a computing system which comprises a computing device in communication with a first Direct-Access Storage Device (“DASD”), second DASD, and a plurality of tape storage devices. This description of Applicants' invention is not meant, however, to limit Applicants' invention computing systems comprising a plurality of tape data drives, as the invention can be implemented generally using a computing system comprising two DASDS and a plurality of non-DASD data storage devices.

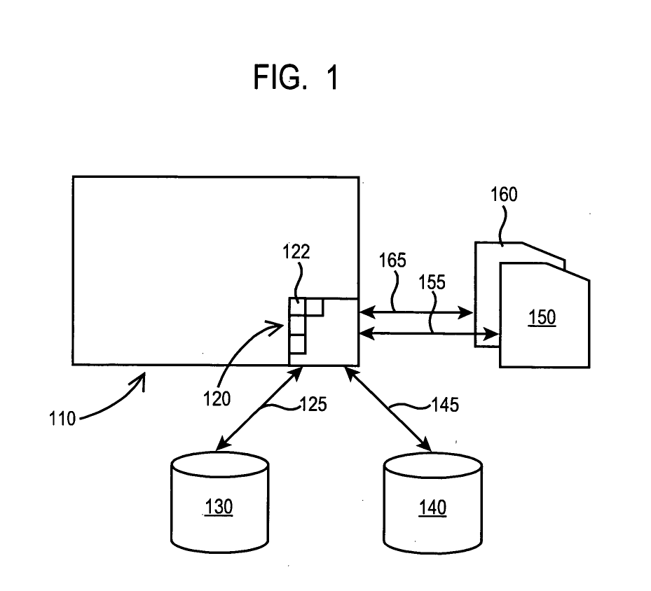

Referring to FIG. 1, Applicants' computing system 100 comprises computing device 110, first DASD 130, second DASD 140, and a plurality of magnetic tape data storage media 150 and 160. By “Direct-Access Storage Device,” Applicants mean a data storage medium/device, wherein the access time for data written thereto is substantially independent of location of that data. By “Non-DASD data storage device,” Applicants mean a data storage medium/device wherein the access time for data written thereto is dependent of location of that data, such as for example magnetic tape data storage media.

Computing device 110 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald). In certain embodiments, computing device 110 further comprises a storage management program 120. The storage management program 120 disposed in computing device 110 comprises functionality to manage the transfer of data to and from various data storage media. In certain embodiments, storage management program 120 comprises the IBM DFSMS implemented in the IBM MVS operating system. In certain embodiments, storage management program 120 comprises storage management policies 122.

In certain embodiments, Applicants' first DASD comprises RAM memory. In certain embodiments, Applicants' first DASD comprises a hard disk drive comprising a magnetic disk storage medium. In certain embodiments, Applicants' first DASD comprises an electronic storage medium, such as and without limitation a PROM, EPROM, EEPROM, Flash PROM, compactflash, smartmedia, and the like. In certain embodiments, Applicants' second DASD comprises RAM memory. In certain embodiments, Applicants' second DASD comprises a hard disk drive comprising a magnetic disk storage medium. In certain embodiments, Applicants' second DASD comprises an electronic storage medium, such as and without limitation a PROM, EPROM, EEPROM, Flash PROM, compactflash, smartmedia, and the like.

In certain embodiments, first DASD 130 is integral with computing device 110. In other embodiments, first DASD 130 is external to computing device 110, and bidirectionally communicates with storage management program 120 using communication link 125. In certain embodiments, communication link 125 is selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, second DASD 140 is integral with computing device 110. In other embodiments, second DASD 140 is external to computing device 110, and bidirectionally communicates with storage management program 120 using communication link 145. In certain embodiments, communication link 145 is selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

Storage management program 120 communicates bidirectionally with tape drive devices capable of reading data from, and writing data to, magnetic tape storage media 150 and 160 using communication links 155 and 165, respectively. In certain embodiments, magnetic tape storage media 150 and 160 are disposed in an automated data storage subsystem comprising a plurality of portable cassettes stored in a plurality of storage slots, and one or more robotic accessors capable of transporting each of the plurality of portable cassettes to and from one or more tape drive devices, wherein each portable cassette comprises a magnetic tape data storage medium, such as tape medium 150 or 160, disposed therein.

In certain embodiments, communication links 155 and 165 are each independently selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

As those skilled in the art will appreciate, a hierarchical storage management system stores data using the most appropriate storage technology, balancing value of the data to the cost of data storage over time. The data comprising an HSM system is sometimes migrated from one storage technology to another storage technology over time. For example, data frequently read and/or updated is initially stored on a data storage medium capable of rapid, random access, such as Applicants' first DASD 130 and second DASD 140. Over time, however, when that data is not longer used frequently, that data may be migrated to a slower but less expensive data storage media, such as magnetic tapes 150 and/or 160.

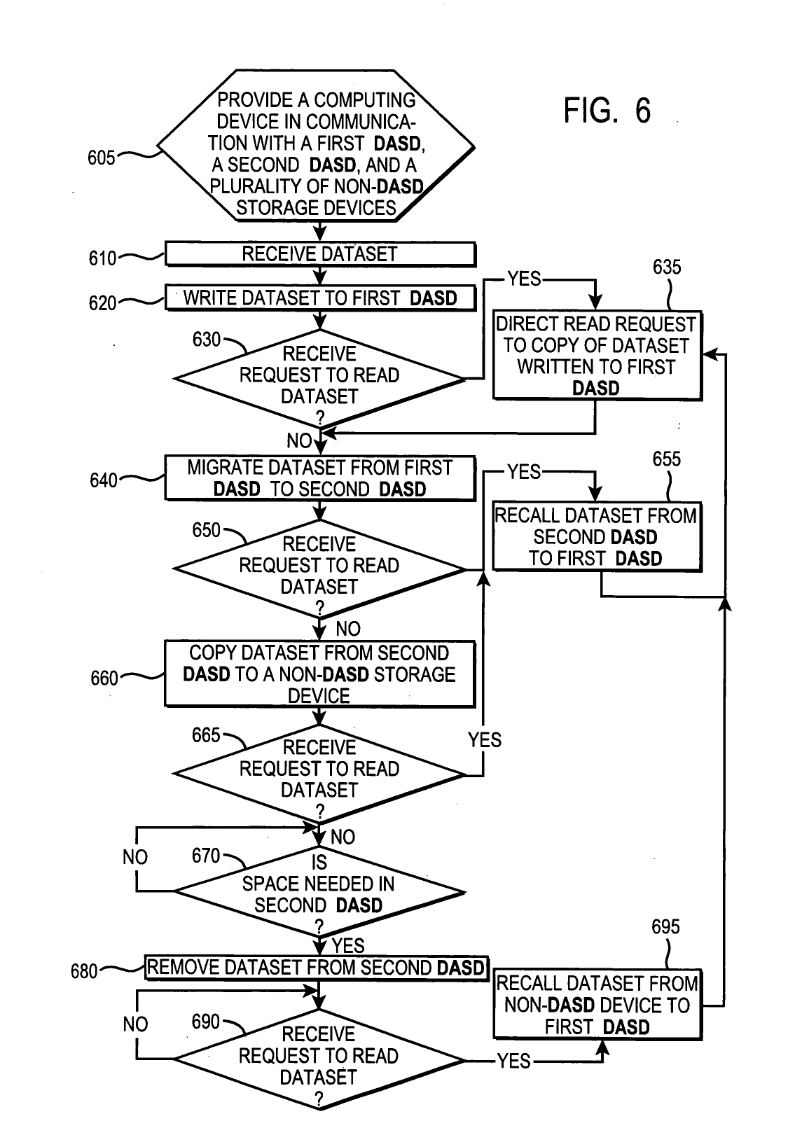

Applicants' invention comprises a method to store information using Applicants' computing system 100. Referring now to FIG. 6, in step 605 Applicants' method provides a computing system, such as system 100 (FIGS. 1, 2, 3, 4, 5) comprising a computing device, such as computing device 110, in communication with a first DASD, such as DASD 130, a second DASD, such as DASD 140, and a plurality of non-DASD data storage media, such as magnetic tapes 150 and 160 in combination with one or more tape drive device devices.

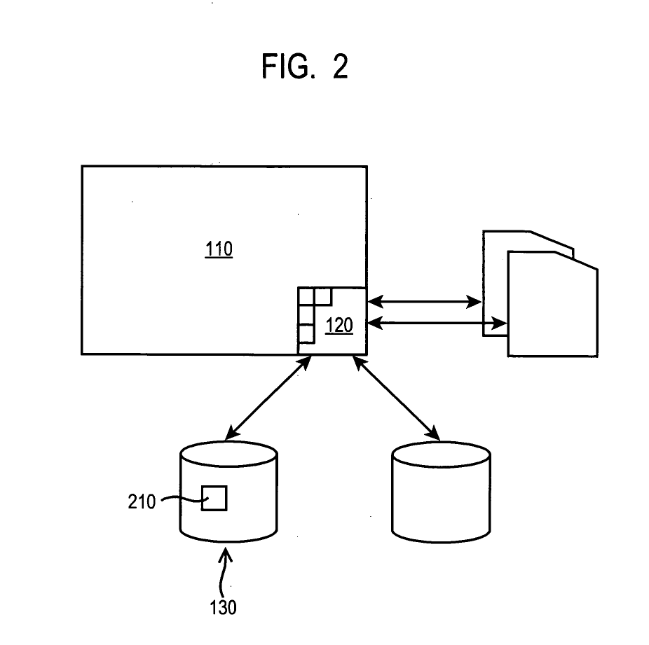

In step 610, Applicants' method receives a dataset. In certain embodiments, the dataset of step 610 is created by a user using computing device 110. Referring now to FIG. 2 in step 620, Applicants' method writes the dataset, such as dataset 210, to Applicants' first DASD, such as DASD 130. In certain embodiments, step 620 is performed by a computing device user. In certain embodiments, step 620 is performed by an application program disposed on the originating computing device. In certain embodiments, step 620 is performed by storage management program 120.

In step 630, Applicants' method determines if a request to read the dataset is received. In certain embodiments, step 630 is performed by storage management program 120. If a request to read the dataset is not received, then Applicants' method transitions from step 630 to step 640. If a request to read the dataset is received, then the method transitions to step 635 wherein the method directs that read request to the copy of the dataset written to the first DASD. Applicants' method transitions from step 635 to step 640.

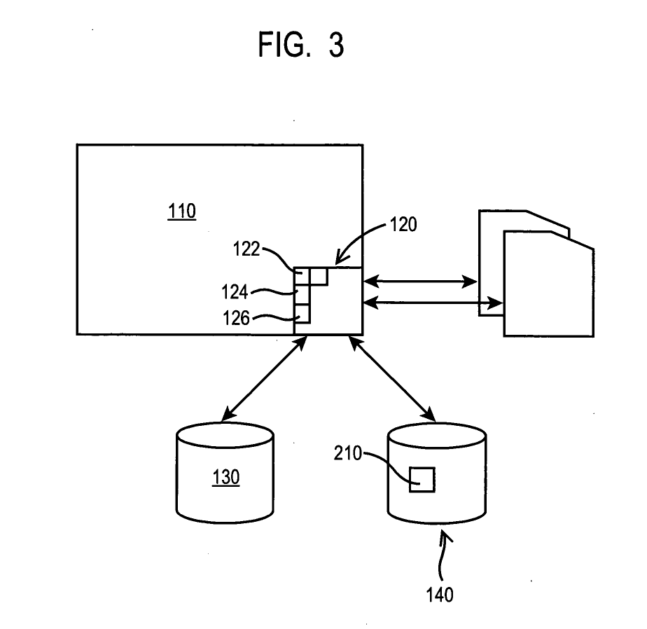

Referring now to FIG. 3 in step 640, Applicants' method migrates the dataset created in step 610, such as dataset 210, from Applicants' first DASD, such as DASD 130 to Applicants' second DASD, such as DASD140. In certain embodiments, step 640 is performed by storage management program 120.

In certain embodiments, storage management program 120 comprises an Interval Migration (“IM”)function 124, wherein that IM function 124 migrates data from Applicants' first DASD to Applicants' second DASD on a scheduled basis at a pre-determined first monitoring interval. In certain of these IM function embodiments, step 640 is performed by Applicants' IM function. In certain embodiments, the monitoring interval is about 60 minutes.

In certain embodiments, storage management program 120 comprises a Primary Storage Management (“PSM”) function 126. In certain embodiments, PSM 126 migrates data from Applicants' first DASD to Applicants' second DASD on a scheduled basis at a pre-determined second monitoring interval, based upon the available storage capacity remaining in the first DASD, and/or based upon storage management policies 122. In certain of these PSM function embodiments, step 640 is performed by Applicants' PSM function. In certain embodiments, Applicants' second monitoring interval is about 24 hours.

In step 650, Applicants' method determines if a request to read the dataset is received. In certain embodiments, step 650 is performed by storage management program 120. If a request to read the dataset is not received, then Applicants' method transitions from step 650 to step 660. If a request to read the dataset is received, then the method transitions to step 655 wherein the method recalls the dataset from the second DASD to the first DASD. Applicants' method transitions from step 655 to step 635 and continues as described herein.

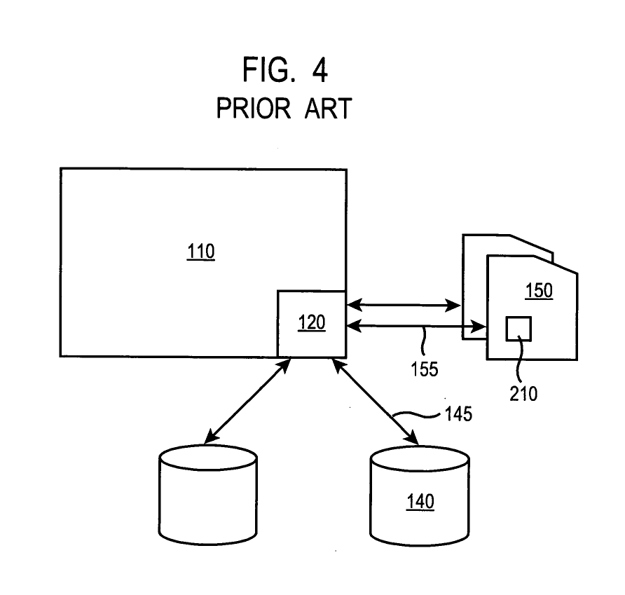

Referring now to FIG. 4, prior art HSM methods, based on anticipated future storage capacity requirements for the second DASD, migrate data, such as dataset 210, from second DASD 140 to magnetic tape storage medium 150. These prior art methods cannot wait to migrate data until additional second DASD storage capacity is actually needed because of the time required to perform the data migration. Therefore, these prior art methods utilize predictive protocols wherein the data is migrated in advance of actual second DASD increased capacity needs.

Applicants have found that such prior art methods often inaccurately predict the future storage capacity needs for the second DASD, and therefore, prematurely migrate data from the second DASD to tape media. Such premature migration can result in increased access time when retrieving data prematurely migrated to one or more magnetic tape storage media.

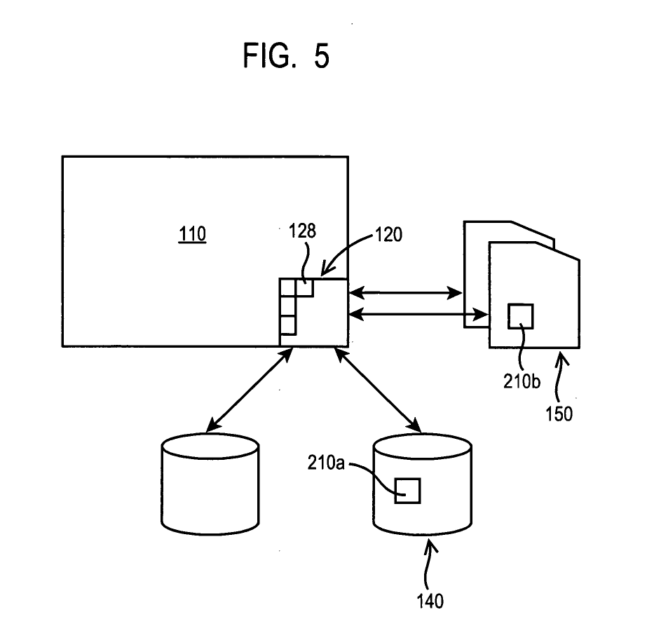

Referring now to FIGS. 5 and 6, based upon the frequency of access for dataset 210, and/or based upon storage management policies 122, in step 660 Applicants' method copies dataset 210 from Applicants' second DASD to one or more magnetic tape storage media 150 and/or 160. In certain embodiments, Applicants' storage management program 120 comprises a Secondary Storage Management (“SSM”) function 128. In certain embodiments, step 660 is performed by SSM function 128. Using Applicants' method, after performing step 660 a first copy of dataset 210, namely dataset 210a, remains written to second DASD 140, and a second copy of dataset 210, namely dataset 210b, is written to tape medium 150.

In step 665, Applicants' method determines if a request to read the dataset is received after copying the dataset to the non-DASD device. In certain embodiments, step 665 is performed by storage management program 120. If a request to read the dataset is not received, then Applicants' method transitions from step 665 to step 670.

If a request to read the dataset is received in step 665, Applicant's method transitions from step 665 to step 655 wherein the method locates and recalls the dataset from the second DASD to the first DASD. Applicants' method transitions from step 655 to step 635 and continues as described herein.

As described above, prior art methods immediately remove a dataset from the second DASD after migrating that dataset from the second DASD to a non-DASD storage device. Using these prior art methods, receiving a read request after migrating the dataset to a non-DASD medium/device necessitates locating the dataset on the non-DASD storage medium/device, such as for example a magnetic tape storage medium. Using Applicant's method, however, receiving a read request in step 665 after copying the data set to a non-DASD device does not require locating the dataset on the non-DASD storage medium/device. Rather using Applicant's method, receiving a read request after step 660 but before step 680 requires locating the dataset on the second DASD device. Those skilled in the art will appreciate that a dataset can be located and recalled from a DASD device much faster than that dataset can be located and recalled from, for example, a magnetic tape.

In step 670, Applicants' method determines if additional storage capacity is presently, i.e. immediately, needed in Applicants' second DASD. In certain embodiments, step 670 is performed by computing device 110. In certain embodiments, step 670 is performed by storage management program 120. In certain embodiments, step 670 is performed by PSM function 126.

If Applicants' method determines in step 670 that additional storage capacity in Applicants' second DASD is not presently required, then the method continues to monitor the storage capacity requirements for the second DASD. If Applicants' method determines in step 670 that additional storage capacity in Applicants' second DASD is presently required, then the method transitions from step 670 to step 680 wherein the method removes the copy of the dataset of step 610, i.e. dataset 210a, from Applicants' second DASD. As those skilled in the art will appreciate, removal of the dataset from Applicants' second DASD can be performed immediately because that dataset was previously copied to a tape medium in step 660. Steps 670 and 680 may be performed at any time after step 660.

In step 690, Applicants' method determines if a request is received to read the dataset of step 610. If Applicants' method determines that a read request for the dataset is not received, then the method continues to monitor for receipt of such a read request. If a read request is received, Applicants' method transitions from step 690 to step 695 wherein the method recalls the dataset from the non-DASD storage device to the first DASD. Applicant's method transitions from step 695 to step 635 and continues as described herein.

The individual steps recited in FIG. 6, may be combined, eliminated, or reordered.

In certain embodiments, Applicants' invention includes instructions residing in storage management program 120 to perform one or more of steps 610, 620, 630, 635, 640, 650, 655, 660, 670, 680, 690, and 695, recited in FIG. 6.

In other embodiments, Applicants' invention includes instructions residing in any other computer program product, where those instructions are executed by a computer external to, or internal to, system 300, to perform one or more of steps 610, 620, 630, 635, 640, 650, 655, 660, 670, 680, 690, and 695, recited in FIG. 6. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to store data, comprising the steps of:
supplying a computing system comprising a computing device, a first DASD in communication with said computing device, a second DASD in communication with said computing device, and a plurality of non-DASD data storage devices in communication with said computing device;
migrating a dataset from said first DASD to said second DASD;
copying said dataset from said second DASD to one or more of said plurality on non-DASD data storage devices.

2. The method of claim 1, further comprising the steps of:
determining if additional storage capacity is presently required in said second DASD;
operative if additional storage capacity is presently required in said second DASD, removing said dataset from said second DASD.

3. The method of claim 2, wherein said supplying a plurality of non-DASD data storage devices comprises:
supplying a plurality of magnetic tape data storage media; and
supplying one or more tape drive devices capable of reading data from, and writing data to, said plurality of magnetic tape data storage media, wherein said one or more tape drive devices are in communication with said computing device.

4. The method of claim 1, wherein said supplying step further comprises supplying a computing device comprising a storage management program, wherein said storage management program performs said migrating step and said copying step.

5. The method of claim 4, wherein said supplying step further comprises supplying a computing device comprising a storage management program comprising an Interval Monitoring function, wherein said Interval Monitoring function performs said migrating step.

6. The method of claim 4, wherein said supplying step further comprises supplying a computing device comprising a storage management program comprising an Primary Storage Management function, wherein said Primary Storage Management function performs said migrating step.

7. The method of claim 4, wherein said supplying step further comprises supplying a computing device comprising a storage management program comprising a Secondary Storage Management function, wherein said Secondary Storage Management function performs said copying step.

8. An article of manufacture comprising a computer useable medium having computer readable program code disposed therein to store data in a computing system comprising a computing device, a first DASD in communication with said computing device, a second DASD in communication with said computing device, and a plurality of non-DASD data storage devices in communication with said computing device, the computer readable program code comprising a series of computer readable program steps to effect:
migrating a dataset from said first DASD to said second DASD;
copying said dataset from said second DASD to one or more of said plurality on non-DASD data storage devices.

9. The article of manufacture of claim 8, said computer readable program code further comprising a series of computer readable program steps to effect:
determining if additional storage capacity is presently required in said second DASD;
operative if additional storage capacity is presently required in said second DASD, removing said dataset from said second DASD.

10. The article of manufacture of claim 8, wherein said plurality of non-DASD data storage devices comprises a plurality of magnetic tape data storage media and one or more tape drive devices capable of reading data from, and writing data to, said plurality of magnetic tape data storage media.

11. The article of manufacture of claim 8, wherein said computing device comprises a storage management program.

12. The article of manufacture of claim 11, wherein said storage management program comprises an Interval Monitoring function.

13. The article of manufacture of claim 11, wherein said storage management program comprises a Primary Storage Management function.

14. The method of claim 11, wherein said storage management program comprises a Secondary Storage Management function.

15. A computer program product usable with a programmable computer processor having computer readable program code embodied therein to store data in a computing system comprising a computing device, a first DASD in communication with said computing device, a second DASD in communication with said computing device, and a plurality of non-DASD data storage devices in communication with said computing device, comprising:
computer readable program code which causes said programmable computer processor to migrate a dataset from said first DASD to said second DASD;
computer readable program code which causes said programmable computer processor to copy said dataset from said second DASD to one or more of said plurality on non-DASD data storage devices.

16. The computer program product of claim 15, further comprising:
computer readable program code which causes said programmable computer processor to determine if additional storage capacity is presently required in said second DASD;
computer readable program code which, if additional storage capacity is presently required in said second DASD, causes said programmable computer processor to remove said dataset from said second DASD.

17. The computer program product of claim 15, wherein said plurality of non-DASD data storage devices comprises a plurality of magnetic tape data storage media and one or more tape drive devices capable of reading data from, and writing data to, said plurality of magnetic tape data storage media.

18. The computer program product of claim 15, wherein said computing device comprises a storage management program.

19. The computer program product of claim 18, wherein said storage management program comprises a Primary Storage Management function.

20. The computer program product of claim 18, wherein said storage management program comprises a Secondary Storage Management function.
